(19) United States
(12) Patent Application Publication
(10) Pub. No.: US 2026/0161975 A1
(43) Pub. Date: Jun. 11, 2026

(54) ARTIFICIAL INTELLIGENCE DEVICE AND METHOD FOR PROVIDING ON-DEMAND SERVICE

(71) Applicant: LG ELECTRONICS INC., Seoul (KR)

(72) Inventors: Wooseong CHUNG, San Jose, CA (US); Hyunchul LEE, Mountain View, CA (US); Jacob SONG, Cupertino, CA (US); Sanghyun BYUN, San Jose, CA (US)

(73) Assignee: LG ELECTRONICS INC., Seoul (KR)

(21) Appl. No.: 19/416,349

(22) Filed: Dec. 11, 2025

Related U.S. Application Data
(60) Provisional application No. 63/730,945, filed on Dec. 11, 2024.

(30) Foreign Application Priority Data
Nov. 12, 2025 (WO) PCT/KR2025/018634

(51) Int. Cl. G06N 5/04

(52) U.S. Cl. CPC G06N 5/04

(57) ABSTRACT

An artificial intelligence device providing an on-demand service is disclosed. An artificial intelligence device according to one embodiment of the present disclosure may comprise an output interface; a memory configured to store a lightweighted on-device AI model; a communication interface configured to communicate with an AI server including a cloud AI model running in a cloud computing environment; and at least one processor configured to: obtain input data, determine an AI model to provide an answer to the input data among the on-device AI model and the cloud AI model based on a modality or a complexity of the obtained input data, obtain the answer through the determined AI model, and output the obtained answer through the output interface.

### CROSS-REFERENCE TO RELATED APPLICATION

Pursuant to 35 U.S.C. § 119, this application claims the benefit of earlier filing date and right of priority to PCT Application No. PCT/KR 2025/018634, filed on Nov. 12, 2025, and also claims the benefit of U.S. Provisional Application No. 63/730945, filed on Dec. 11, 2024, the contents of which are all incorporated by reference herein in their entirety.

### BACKGROUND OF THE INVENTION

### 1. Field of the Invention

The present invention relates to an artificial intelligence device, and more particularly, to a method for providing an on-demand service to a customer.

### 2. Discussion of the Related Art

Traditionally, customer service, especially maintenance request processing, has encountered a wide range of issues, from simple software error to complex hardware component replacement, however, these have been difficult to effectively analyze and respond to.

This complexity often resulted in repeated call transfers between a service representative and a customer, making it difficult to pinpoint a true cause of a problem. In particular, insufficient or missing information to understand the context of the problem led to unnecessary an inspection and a replacement, resulting in inefficiency.

This increases the time required to resolve issues, leaving customers frustrated with complex and delayed service procedures. Furthermore, this inconvenience has become a major factor in reducing customer loyalty and trust in the brand.

Conventional technology lacked intelligent support system capable of automatically classifying or quickly responding to these issues, forcing us to rely on human-centric response.

Additionally, an application of large-scale artificial intelligence (AI)-based customer service has been difficult due to a system cost and a processing delay.

### SUMMARY OF THE INVENTION

A purpose of the present disclosure may be to provide a multimodal AI model capable of handling various types of user queries.

A purpose of the present disclosure may be to provide an on-demand service with a minimal latency without incurring large cost through an on-device AI model and a cloud AI model.

A purpose of the present disclosure may be to provide the on-demand service that processes a simple type of a query through the on-device model and a complex type of a query through the cloud AI model.

An artificial intelligence device according to one embodiment of the present disclosure may comprise an output interface; a memory configured to store a lightweighted on-device AI model; a communication interface configured to communicate with an AI server including a cloud AI model running in a cloud computing environment; and at least one processor configured to: obtain input data, determine an AI model to provide an answer to the input data among the on-device AI model and the cloud AI model based on a modality or a complexity of the obtained input data, obtain the answer through the determined AI model, and output the obtained answer through the output interface.

A method of providing an on-demand service according to one embodiment of the present disclosure may comprise obtaining input data; determining an AI model to provide an answer to the input data among an on-device AI model and a cloud AI model based on a modality or a complexity of the obtained input data; obtaining the answer through the determined AI model; and outputting the obtained answer.

A non-transitory recording medium storing computer-readable instructions that, when executed by a device, cause the device to perform a method according to one embodiment of the present disclosure the method may comprise obtaining input data; determining an AI model to provide an answer to the input data among an on-device AI model and a cloud AI model based on a modality or a complexity of the obtained input data; obtaining the answer through the determined AI model; and outputting the obtained answer.

According to an embodiment of the present disclosure, an efficient on-demand service may be provided by selectively applying the on-device AI model and the cloud AI model to a user's query.

According to an embodiment of the present disclosure, a customer latency may be reduced by processing only important service request through the cloud AI model.

According to embodiments of the present disclosure, a complex analysis of an image or a situation is not required, and a server operating cost for the cloud AI model can be significantly reduced by processing less critical tasks—such as a service agent providing an instruction or ordering replacement parts—through the on-device AI model within the device.

According to embodiments of the present disclosure, a complexity of a multimodal AI agent may be significantly improved through an endpoint simplification and log-based direct learning. This enables the implementation of AI agent capable of performing expert-level functions in all maintenance and service area.

### BRIEF DESCRIPTION OF THE DRAWINGS

FIG. 1 is a block diagram for illustrating elements of an artificial intelligence device according to an embodiment of the present disclosure.

FIG. 2 is a diagram for illustrating the configuration of an artificial intelligence server according to an embodiment of the present disclosure.

FIGS. 3 and 4 are drawings for explaining a method of providing an on-demand service through a plurality of AI models of a system according to one embodiment of the present disclosure.

FIG. 5 is a diagram illustrating a fine tuning process of a cloud AI model according to an embodiment of the present disclosure.

FIG. 6 is a diagram illustrating a process for supporting customer maintenance of an application using a cloud AI model according to one embodiment of the present disclosure.

FIG. 7 is a diagram showing an example of interacting with a customer using an on-device AI model and a cloud AI model according to an embodiment of the present disclosure.

FIG. 8 is a diagram illustrating a process for determining an AI model to provide an answer to input data according to one embodiment of the present disclosure.

### DETAILED DESCRIPTION OF THE PREFERRED EMBODIMENTS

Artificial intelligence refers to the field of researching artificial intelligence or methodology to create it, and machine learning refers to the field of defining various problems dealt with in the field of artificial intelligence and researching methodology to solve them.

Machine learning is also defined as an algorithm that improves the performance of a task through consistent experience.

Artificial Neural Network (ANN) is a model used in machine learning, it may refer to an overall model with problem-solving capability that is composed of artificial neurons (nodes) that form a network through the combination of synapses.

Artificial neural network may be defined by connection pattern between neurons in different layers, a learning process that updates model parameter, and an activation function that generates output value.

An artificial neural network may include an input layer, an output layer, and optionally one or more hidden layers. Each layer may include one or more neurons, and the artificial neural network may include synapse connecting neurons. In an artificial neural network, each neuron may output the input signals input through the synapse, weight, and value of activation function for bias.

Model parameter refer to a parameter determined through learning and includes the weight of synapse connection and the bias of neurons. Hyperparameter refer to a parameter that must be set before learning in a machine learning algorithm and includes learning rate, number of repetition, mini-batch size, initialization function, etc.

The purpose of learning an artificial neural network may be seen as determining model parameter that minimize the loss function. The loss function may be used as an indicator to determine optimal model parameter during the learning process of an artificial neural network.

Machine learning may be classified into supervised learning, unsupervised learning, and reinforcement learning depending on the learning method.

Supervised learning refers to a method of training an artificial neural network with a label for the learning data given, a label may mean the correct answer (or result value) that the artificial neural network must infer when learning data is input to the artificial neural network.

Unsupervised learning may refer to a method of training an artificial neural network in a state where no label for training data is given.

Reinforcement learning may refer to a learning method in which an agent defined within an environment learns to select an action or action sequence that maximizes the cumulative reward in each state.

Among artificial neural networks, machine learning implemented with a deep neural network (DNN) that includes a plurality of hidden layers is also called deep learning, and deep learning is a part of machine learning.

Hereinafter, machine learning is used to include deep learning.

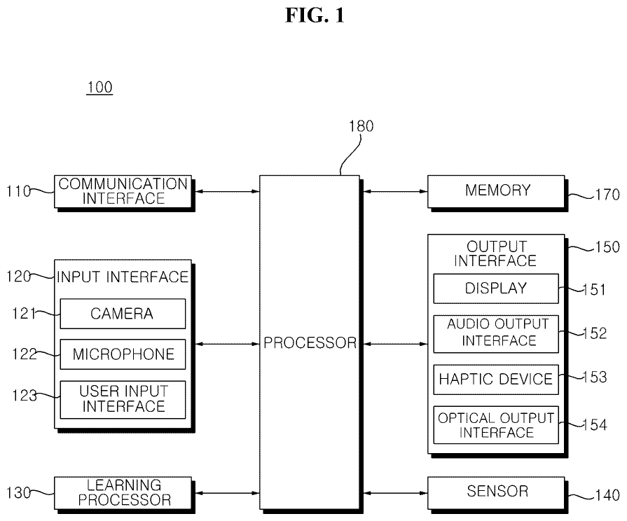

FIG. 1 is a block diagram for illustrating elements of an artificial intelligence device according to an embodiment of the present disclosure.

The artificial intelligence device 100 may be implemented as a fixed or movable device such as a TV, a projector, a mobile phone, a smartphone, a desktop computer, a laptop, a digital broadcasting terminal, a PDA (personal digital assistant), a PMP (portable multimedia player), a navigation, a tablet PC, a wearable device, and a set-top boxe(STB), a DMB receiver, a radio, a washing machine, a refrigerator, a desktop computer, a digital signage, a robot, a vehicle, etc.

Referring to FIG. 1, the artificial intelligence device 100 may include a communication interface 110, an input interface 120, a learning processor 130, a sensor 140, an output interface 150, a memory 170, and a processor 180.

The communication interface 110 may transmit and receive data with external device such as other artificial intelligence device or the AI server 200 using wired or wireless communication technology. For example, the communication interface 110 may transmit and receive sensor information, user input, learning model, and control signal with external device.

Communication technologies used by the communication interface 110 include Global System for Mobile communication (GSM), Code Division Multi Access (CDMA), Long Term Evolution (LTE), 5G, Wireless LAN (WLAN), and Wireless-Fidelity (Wi-Fi)., Bluetooth (Bluetooth), RFID (Radio Frequency Identification), Infrared Data Association (IrDA), ZigBee, NFC (Near Field Communication), etc.

The input interface 120 may obtain various types of data.

The input interface 120 may include a camera 121 for capturing image, a microphone 122 for receiving audio signals, and a user input interface 123 for receiving information from a user.

The camera 121 or the microphone 122 is treated as a sensor, and the signal obtained from the camera 121 or the microphone 122 may be called sensing data or sensor information.

The input interface 120 may obtain training data for model learning and input data to be used when obtaining an output using the learning model. The input interface 120 may obtain unprocessed input data, and in this case, the processor 180 or the learning processor 130 may extract input feature by preprocessing the input data.

The camera 121 processes image frame such as still image or moving image obtained by an image sensor in video call mode or photographing mode. Processed image frame may be displayed on display 151 or stored in memory 170.

The microphone 122 processes external acoustic signal into electrical voice data. The processed voice data may be utilized in various ways depending on the function (or application being executed) being performed by the artificial intelligence device 100. Meanwhile, various noise removal algorithms may be applied to the microphone 122 to remove noise generated in the process of receiving an external acoustic signal.

The user input interface 123 is for receiving information from the user, when information is input through the user input interface 123, the processor 180 may control the operation of the artificial intelligence device 100 to correspond to the input information.

The user input interface 123 is a mechanical input means (or mechanical key, for example, a button, dome switch, jog wheel, or jog switch located on the front/rear or side of the artificial intelligence device 100). etc.) and a touch input means.

As an example, the touch input may consist of a virtual key, soft key, or visual key displayed on the touch screen through software processing, or a touch key placed in a part other than the touch screen.

The learning processor 130 may train a model composed of an artificial neural network using training data. The learned artificial neural network may be referred to as a learning model. A learning model may be used to infer a result value for new input data other than learning data, and the inferred value may be used as the basis for a decision to perform an operation.

The learning processor 130 may perform AI processing together with the learning processor 240 of the AI server 200.

The learning processor 130 may include memory integrated or implemented in artificial intelligence device 100. The learning processor 130 may be implemented using the memory 170, an external memory directly coupled to the artificial intelligence device 100, or a memory maintained in an external device.

The sensor 140 may obtain at least one of internal information of the artificial intelligence device 100, information on the surrounding environment of the artificial intelligence device 100, or user information using various sensors.

The sensor 140 may include at least one of a proximity sensor, an illumination sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar sensor, or a radar sensor.

The output interface 150 may generate output related to vision, hearing, or tactile sensation.

The output interface 150 may include a display 151 that outputs an image, an audio output interface 152 that outputs audio, a haptic device 153 that outputs tactile information, and an optical output interface 154 that outputs light.

The display 151 displays (outputs) information processed by the artificial intelligence device 100. For example, the display 151 may display execution screen information of an application running on the artificial intelligence device 100, or user interface (UI) and graphic user interface (GUI) information according to the execution screen information.

The display 151 may be implemented as a touch screen by forming a mutual layer structure or being integrated with the touch sensor. The touch screen functions as a user input interface 123 that provides an input interface between the artificial intelligence device 100 and the user, and may simultaneously provide an output interface between the artificial intelligence device 100 and the user.

The audio output interface 152 may output audio data received from the communication interface 110 or stored in the memory 170 in call signal reception, call mode or recording mode, voice recognition mode, broadcast reception mode, etc.

The audio output interface 152 may include at least one of a receiver, a speaker, or a buzzer.

The haptic device 153 generates various tactile effects that the user may feel. A representative example of a tactile effect generated by the haptic device 153 may be vibration.

The light output interface 154 uses light from the light source of the artificial intelligence device 100 to output a signal to notify that an event has occurred. Examples of events that occur in the artificial intelligence device 100 may include receiving a message, receiving a call signal, a missed call, an alarm, a schedule notification, receiving an email, receiving information through an application, etc.

The memory 170 may store data supporting various functions of the artificial intelligence device 100. For example, the memory 170 may store input data obtained from the input interface 120, learning data, learning model, learning history, etc.

The processor 180 may determine at least one executable operation of the artificial intelligence device 100 based on information determined or generated using a data analysis algorithm or a machine learning algorithm.

The processor 180 may control the elements of the artificial intelligence device 100 to perform the determined operation.

To this end, the processor 180 may request, search, receive, or utilize data from the learning processor 130 or the memory 170, and may control elements of the artificial intelligence device 100 to be performed an operation that is predicted or an operation that is determined to be desirable among the at least one executable operation.

If linkage with an external device is necessary to perform a determined operation, the processor 180 may generate a control signal to control the external device and transmit the generated control signal to the external device.

The processor 180 may obtain intent information for user input and determine the user's request based on the obtained intent information.

The processor 180 may obtain intent information corresponding to the user input using at least one of a STT (Speech To Text) engine for converting voice input into a character string or a Natural Language Processing (NLP) engine for acquiring intent information of natural language.

At least one of the STT engine and the NLP engine may be composed of at least a portion of an artificial neural network learned according to a machine learning algorithm. And, at least one of the STT engine or the NLP engine may be learned by the learning processor 130, learned by the learning processor 240 of the AI server 200, or learned by distributed processing thereof.

The processor 180 may collect history information including the user's feedback on the operation of the artificial intelligence device 100, to store it in the memory 170 or the learning processor 130 or the AI server 200, etc. and transmit it to external device. The collected historical information may be used to update the learning model.

The processor 180 may control at least some of the elements of the artificial intelligence device 100 to run an application program stored in the memory 170.

The processor 180 may operate two or more of the elements included in the artificial intelligence device 100 in combination with each other in order to run the application program.

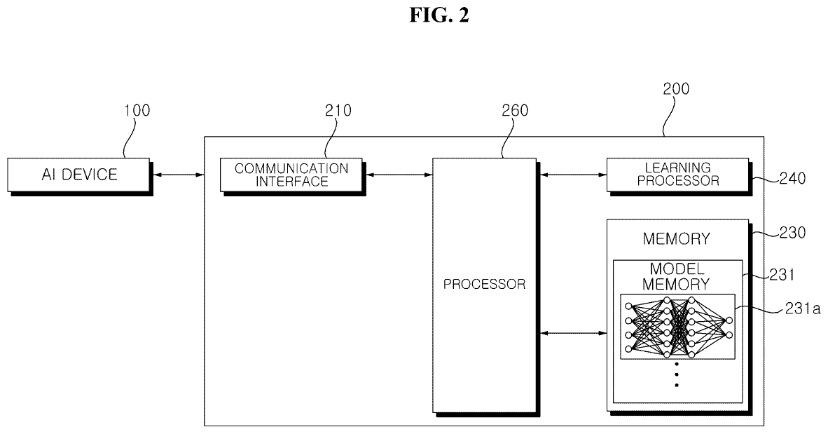

FIG. 2 is a diagram for illustrating the configuration of an artificial intelligence server according to an embodiment of the present disclosure.

Referring to FIG. 2, the AI server 200 may refer to a device that trains an artificial neural network using a machine learning algorithm or uses a learned artificial neural network.

The AI server 200 may be composed of a plurality of servers to perform distributed processing, and may be defined as a 5G network. The AI server 200 may be included as a part of the artificial intelligence device 100 and may perform at least part of the AI processing.

The AI server 200 may include a communication interface 210, a memory 230, a learning processor 240, and a processor 260.

The communication interface 210 may transmit and receive data with an external device such as the artificial intelligence device 100.

The memory 230 may include a model memory 231. The model memory 231 may store a model (or artificial neural network, 231a) that is being trained or has been learned through the learning processor 240.

The learning processor 240 may train the artificial neural network 231a using training data. The learning model may be used while mounted on the AI server 200 of the artificial neural network, or may be mounted and used on an external device such as the artificial intelligence device 100.

The learning model may be implemented in hardware, software, or a combination of hardware and software. When part or all of the learning model is implemented as software, one or more instructions constituting the learning model may be stored in the memory 230.

The processor 260 may infer a result value for new input data using a learning model and generate a response or control command based on the inferred result value.

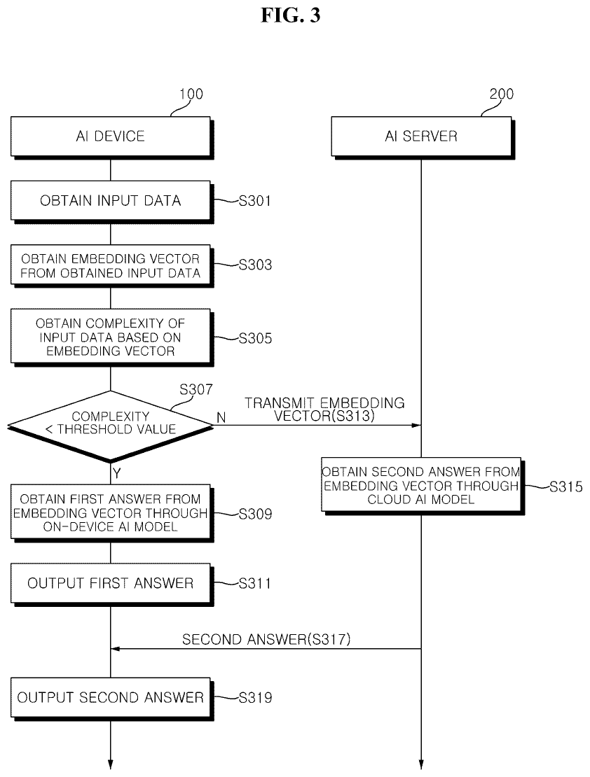

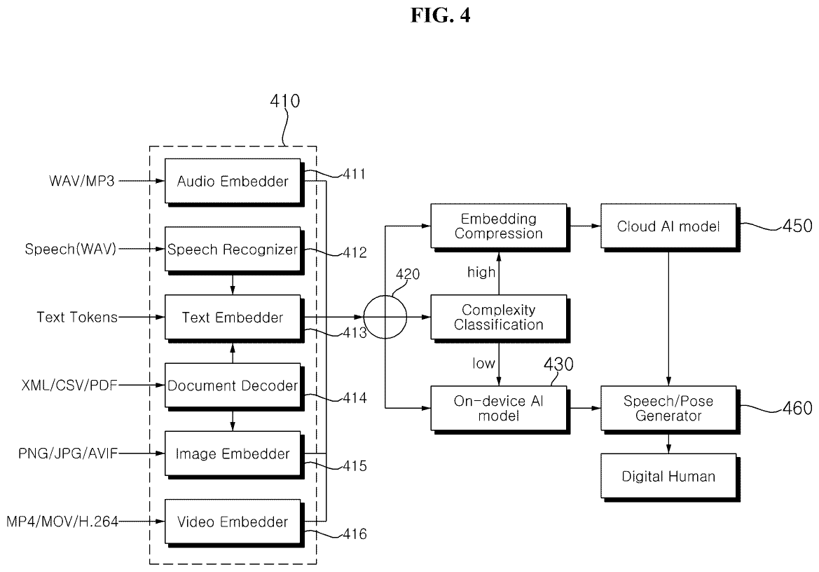

FIGS. 3 and 4 are drawings for explaining a method of providing an on-demand service through a plurality of AI models of a system according to one embodiment of the present disclosure.

Hereinafter, one or more processors 180 may be provided.

Referring to FIG. 3, the processor 180 of the AI device 100 may obtain input data S301.

In the embodiment, the input data may include one or more of a text, an audio, a voice, a video, an image, or a document. The input data may be referred to as modality data.

The processor 180 may receive the input data input by the user through the input interface 120.

The processor 180 of the AI device 100 may obtain an embedding vector from the obtained input data S303.

The encoder 410 provided in the processor 180 may preprocess the input data and output the embedding vector from the preprocessed data. The encoder 410 may perform processes such as a normalization and a tokenization on the input data and then output the embedding vector that compresses the input data.

Referring to FIG. 4, the encoder 410 may include an audio embedder 411, a speech recognizer 412, a text embedder 413, a document decoder 414, an image embedder 415, and a video embedder 416. The encoder 410 may be included in the processor 180 or may be provided separately from the processor 180.

The audio embedder 411 may convert an audio into an embedding vector. The audio may have a WAV format or an MPE3 format.

The speech recognizer 412 may convert speech data corresponding to a speech into a text. The speech data may have a WAV format.

A text embedding 413 may convert a text into an embedding vector. The text may be composed of tokenized text tokens.

A document decoder 414 may convert a document into an embedding vector. The document may have any of the following formats: XML format, CSV format, or PDF format.

An image embedding device 415 may convert an image into an embedding vector. The image may have any one of the following formats: PNG format, JPG format, or AVIF format.

A video embedder 416 may convert a video into an embedding vector. The video may have any one of the following formats: MP4 format, MOV format, or H.264 format.

The processor 180 of the AI device 100 may obtain a complexity of input data based on the embedding vector S305.

The complexity of input data may refer to a density of information contained in the input data, a characteristics of the information, a diversity of those characteristics, or an amount of computation required to process the data. The complexity may also be referred to as a query complexity.

A lightweight converter 420 provided in the processor 180 may calculate the complexity of input data by inputting one or more embedding vectors.

The lightweight transformer 420 may be a model that infers the complexity of input data from an embedding vector. The lightweight transformer 420 may be a lightweight model with fewer than 100 million parameters.

The lightweight converter 420 may be a supervised learning model using a learning embedding vector and a label indicating the complexity matched to the learning embedding vectors. The lightweight converter 420 may have a reduced computational load due to its small number of parameters, resulting in a shorter response time and its low memory requirements may facilitate its installation on the AI device 100.

The processor 180 of the AI device 100 may obtain a first answer from the embedding vector through the on-device AI model 430 S309 when the obtained complexity is less than a threshold value S307, and may output the obtained first answer through the output interface 150 S311.

The threshold value may be a value used to determine which model among the on-device AI model 430 or the cloud AI model 450 will provide an answer to the input data.

The processor 180 may determine a model to obtain the answer as the on-device AI model 430 if the obtained complexity is less than the threshold value, and may determine the model to obtain the answer as the cloud AI model 450 if the obtained complexity is greater than the threshold value.

The on-device AI model 430 is a large language model equipped in the AI device 100, and may be a lightweight model that outputs the answer from text input using a lightweight technique. The lightweight technique may include a quantization technique that converts 16-bit floating point (FP16) numbers into 4-bit integers (INT4) and a KV-cache pruning technique for improved on-device runtime.

The quantization technique may be a technique that converts all numbers of the on-device AI model 430 into very low-precision integers (4 bits).

The KV-cache pruning technique is a technique that stores Key (K) and Value (V) vectors of previously generated tokens in memory space when LLM sequentially generates text, and selectively removes vectors (or caches) that are unnecessary or have a small impact on inference.

The on-device AI model 430 may reduce a physical size of the model through quantization techniques and reduce a memory load and a latency through KV-cache pruning technique. In this sense, the on-device AI model 430 may be referred to as a TinyLLM.

The on-device AI model 430 may be stored in the memory 170 or processor 180 of the AI device 100. The on-device AI model 430 may be provided in the form of a software or a hardware.

When the on-device AI model 430 is provided in a software form, the on-device AI model 430 may be executed through the processor 180 or a separate neural processing unit (NPU).

When the on-device AI model 430 is provided in a hardware form, the on-device AI model 430 may be provided as either an application-specific integrated circuit (ASIC) or a field-programmable gate array (FPGA).

The on-device AI model 430 may perform a Device Information Retrieval function, a Customer Information Query function, and a Lightweight Image Generation function in response to the input data. The on-device AI model 430 may obtain a result of performing the corresponding a function as the first answer.

The device information retrieval function may be a function that requests and obtains data such as an operating system, a hardware status, a configuration setting, an operating status, and model information of of a physical device (smartphone, tablet, etc.) or an home appliance on which an on-device AI model 430 is running.

The customer information query function may be a function that accesses a database or a system to retrieve a specific customer's account information, a service history, a preference, a previous inquiry history, etc.

Ther lightweight image generation function may be a function to quickly create a simple graphic, an icon, a template image, or very small resolution image using relatively few computational resource.

The cloud AI model 450 is a model installed in the AI server 200 and may be a model that performs highly complex tasks requiring in-depth understanding. The cloud AI model 450 may output a second answer from the input data.

The cloud AI model 450 is a large language model (LLM) located in a cloud computing environment outside of the AI device 100, and may be a model that processes complex and massive input data (long sequence length, etc.) that exceeds a processing limit of the on-device AI model 430, and outputs a high-quality answer by utilizing an expertise of an external database through a linkage with a data search API.

The cloud AI model 450 may be an LLM with over 70 billion parameters to handle highly complex tasks requiring in-depth understanding of a long-form video, an audio, or a document. The cloud AI model 450 may be a model utilizing the aforementioned quantization technique and an attention sink technique.

The attention sink technique may be an efficiency improvement technique proposed to solve the problem of rapid increase in memory and computational amount that occurs when LLM processes a long text or a long sequence.

The attention sink technique may be a technique that permanently preserves a few initial tokens as sink tokens to efficiently process a long sequence, and continuously refers to the sink tokens when processing the long sequence in a sliding window manner.

The cloud AI model 450 may be a model in which a full attention technique and a sparse local attention technique are additionally used.

The full attention technique may be a technique that understands a context through a relationship between a current token and all previous tokens in the entire sequence.

The sparse local attention technique may be a technique that apply attention to only some token pairs rather than all tokens, in order to improve a complexity of full attention technique.

The cloud AI model 450 may be referred to as a cloud AI agent.

The processor 180 of the AI device 100 may transmit the embedding vector to the AI server 200 through the communication interface 110 S313when the obtained complexity is greater than a threshold value S307.

When the complexity of the embedding vector is greater than the threshold value, the processor 180 may transmit the embedding vector or data compressing the embedding vector to the AI server 200 through the communication interface 110.

The processor 180 may compress the embedding vector into a low-rank tensor (tensor learning decomposition) and transmit it to a cloud AI model 450 provided as FaaS (Function as a Service).

In another embodiment, the processor 180 may convert the input data into a plurality of input tokens. An input token may be an integer ID, which is the smallest unit converted for processing by the AI model. The processor 180 may determine a modality of the input data based on the plurality of input tokens. The modality may indicate a type of data the input tokens belong to.

The processor 180 may determine an AI model to provide a response to input data as a cloud AI model 450 when the determined modality is any one of audio, video, image, or document. The processor 180 may convert input tokens into embedding vectors and provide the converted embedding vectors to the AI server 200.

In another embodiment, the processor 180 may determine that the complexity of the embedding vector is greater than or equal to a threshold value when the modality is any one of audio, video, image, or document.

The processor 260 of the AI server 200 may obtain a second answer from the embedding vector through the cloud AI model 450 S315 and transmit the obtained second answer to the AI device 100 S317.

The cloud AI model 450 may perform a multimodal understanding function, a long-context-aware attention function, and a retrieval-augmented generation of solution function based on the embedding vector, and may obtain the result of performing the functions as the second answer.

The cloud AI model 450 may be trained based on a maintenance chat log and an in-depth technical documentation describing the product.

The multimodal understanding function may be a function to comprehensively analyze and interpret input data in different formats (modes), such as text, audio, video, and image. The multimodal understanding function may a function to connect the video, the audio, a text transcript of a speech, and embedded vectors of related document texts into a common semantic space, thereby understanding a context of the entire input.

For example, when a video file is input, the cloud AI model 450 may simultaneously understand a visual situation occurring in the video and a speaker's explanation from the audio to derive a comprehensive conclusion.

The long-context-aware attention function may be a function to recognize a situation by focusing on and not forgetting important information that is temporally distant within long and complex sequence (long-form video/audio, large amounts of log).

The retrieval-augmented generation of solution function may be a function that augments an answer and generates a specific solution by retrieving the latest information or specialized data of a specific organization through an external database, a document, a web search, etc. in addition to the knowledge (internal knowledge) learned by the cloud AI model 450.

The cloud AI model 450 may have a carefully designed data retrieval Application Programming Interface (API) built in to facilitate access to the proprietary database.

The data retrieval API is provided as a set of callable commands in a header of the cloud AI model 450, allowing the cloud AI model 450 to directly call this external tool as needed to retrieve accurate and up-to-date data.

Additionally, as the cloud AI model 450 is fine-tuned through the search API's command set itself, the model's understanding of when and which API to call (tool-use/function calling) and its complexity may be improved. This may maximize a RAG performance and a solution generation accuracy for a specific task.

The cloud AI model 450 may access all customer support APIs, including but not limited to order acceptance, parts replacement, service maintenance schedule management, and service logging. Like the search API, the cloud AI model 450 may be fine-tuned through an agent API call.

The processor 180 of the AI device 100 may output the second answer received from the AI server 200 through the output interface 150 S319.

The processor 180 may output the second answer output to the cloud AI model 450 through a digital human (or digital human assistant). The digital human may be an avatar that provides an experience similar to direct interaction with the user.

If the second answer is a text, the processor 180 may convert the text into speech. The processor 180 may estimate the converted speech and a facial pose that matches the speech, and display the digital human assistant reflecting the estimated facial pose on the display 151 while outputting the speech through the audio interface 152.

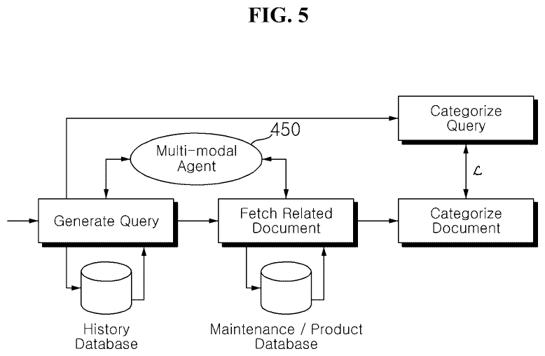

FIG. 5 is a diagram illustrating a fine tuning process of a cloud AI model according to an embodiment of the present disclosure.

The cloud AI model 450 may be referred to as a multimodal agent 450 or a multimodal AI agent 450.

The multimodal agent 450 may be fine-tuned through three stages of low-rank adaptation to enhance its ability to pool data from over a million documents in the database.

First, the multimodal agent 450 may call all API endpoints and assign appropriate extension keywords (or document keywords) to each document.

The multimodal agent 450 may then generate a sample query from a past customer log stored in the history database (Generate Query). The multimodal agent 450 may then be requested to retrieve relevant documents related to the sample query in a tree structure from the maintenance/product database (Fetch Related Document). During this process, the documents may reference each other, where appropriate.

The multimodal agent 450 may be asked to categorize a given query (Categorize Query). This may result in the generation of a query keyword.

The multimodal agent 450 may classify pooled documents to obtain a document keyword.

Afterwards, the multimodal agent 450 may perform loss (L)-based fine-tuning by comparing the query keyword and the document keyword.

In this way, according to an embodiment of the present disclosure, a loss between the query keywords and the document keyword may be optimized through the fine-tuning, thereby improving the ability of a multimodal agent to accurately fetch the document that best match the intent of a query rather than simple keyword matching.

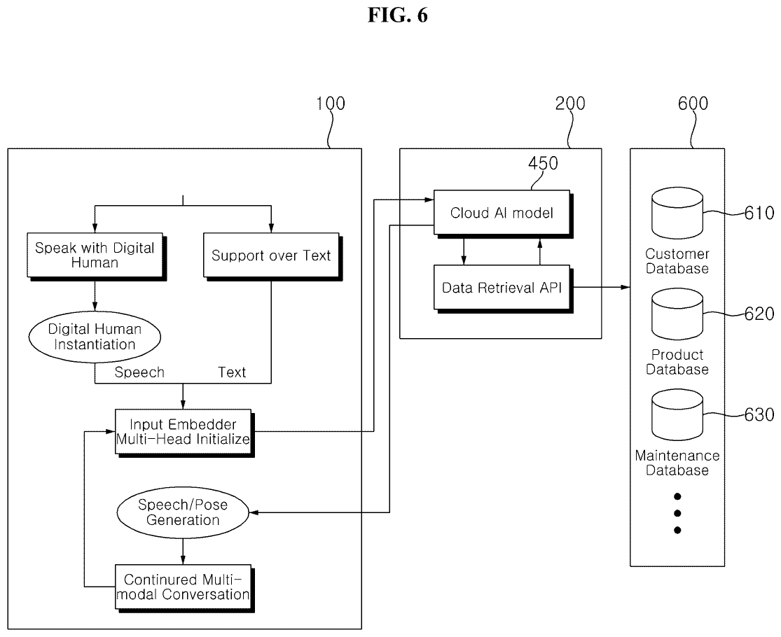

FIG. 6 is a diagram illustrating a process for supporting customer maintenance of an application using a cloud AI model according to one embodiment of the present disclosure.

The AI device 100 may be a mobile terminal such as a customer's smartphone or a fixed terminal such as a TV.

The AI device 100 may obtain input data from the customer. The input data may include one or more of text, audio, video, voice, or documents. For example, the AI device 100 may obtain the customer's voice through a voice conversation with a digital human (Speak with Digital Human). When the customer's voice is received, the AI device 100 may activate the digital human instantiated for a specific purpose to generate a response (Digital Human Instantiation).

As another example, the AI device 100 may receive a text entered by a customer through a chatbot (Support over Text).

The AI device 100 may convert the input data including a customer's voice or text into the embedding vector, and prepare to calculate a contextual importance between parts of the input data in parallel based on the converted embedding vector (Input Embedder Multi-Head Initialize).

The AI device 100 may transmit the embedding vector to the cloud AI model 450 of the AI server 200. The cloud AI model 450 may generate an answer through a data search API based on the embedding vector. The cloud AI model 450 may obtain an intent of the input data by understanding the context through a multi-head attention mechanism based on the embedding vector. The cloud AI model 450 may determine what type of external knowledge is required based on the obtained intent and, based on the determination result, generate a search request including one or more keywords or search vectors required for the search.

The cloud AI model 450 may transmit a search request generated through a data retrieval API to an external server 600. The cloud AI model 450 may access the external server 600 through the data retrieval API and perform a function of searching and fetching related documents or data.

The external server 600 may include a customer database 610, a product database 620, and a maintenance database 630.

The customer database 610 may store user history-related data including customer information, a consultation record, and a previous log.

The product database 620 may store detailed information and manuals about a product or a service.

The maintenance database 630 may include a product maintenance record, a troubleshooting procedure, and a technical documentation.

The cloud AI model 450 may retrieve a document chunk or a document most relevant to the search request through a keyword similarity-based search or a vector similarity-based search.

A process like this may be a core operating principle of the Retrieval-Augmented Generation (RAG) architecture of the cloud AI model 450 or the creation of a search augmentation solution.

The AI server 200 may generate an answer based on the customer's intention and document information obtained through the data search API, and transmit the generated answer to the AI device 100.

The AI device 100 may generate a voice and a pose of the digital human corresponding to a response received from the AI server 200 (Speech/Pose Generation), and may display the generated voice and pose of the digital human through a display 151.

In this way, according to embodiments of the present disclosure, a high-quality answer may be provided to customers by utilizing a massive real-time/expert database beyond a limitation of self-learning data.

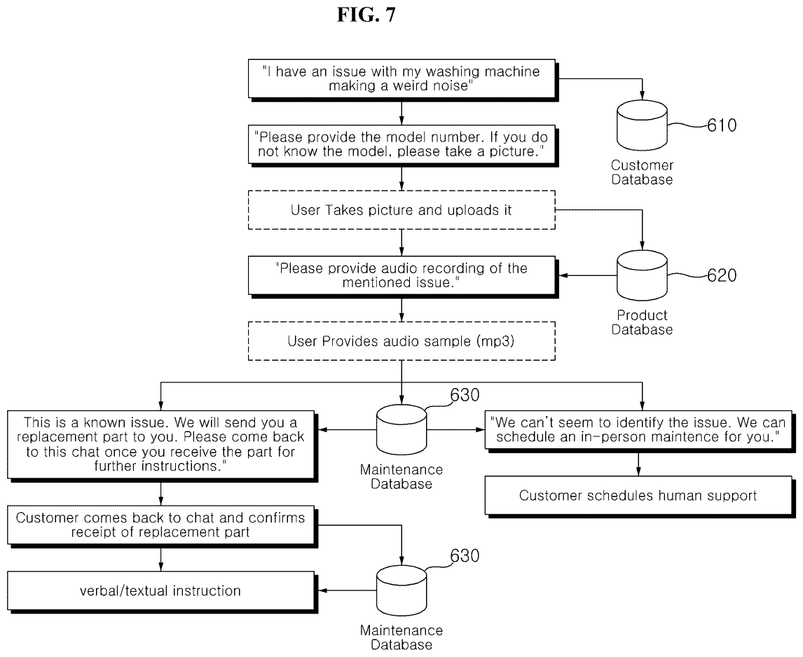

FIG. 7 is a diagram showing an example of interacting with a customer using an on-device AI model and a cloud AI model according to an embodiment of the present disclosure.

In particular, FIG. 7 shows an example of a conversation in which, when a customer has a noise problem with a home appliance, a simple conversation is processed through the on-device AI model 430 of the AI device 100, and the cloud AI model 450 of the AI server 200 accesses each database to provide an appropriate answer using the obtained data.

The solid line boundary box is a task processed by the on-device AI model 430, and a dotted line boundary box is a task processed by the cloud AI model 450.

The AI device 100 may output an answer through a digital human or output an answer through a text.

AI device 100 may receive a voice indicating that a noise problem has occurred in a washing machine: <“I have an issue with my washing machine making a weird noise”>.

The AI device 100 may respond to the voice received through the on-device AI model 430 to output a response indicating whether to provide the model number or to provide a picture of the model: <“Please provide the model number. If you do not know the model, please take a picture”>.

The AI device 100 may convert an image taken and uploaded by a customer into an embedding vector and transmit the converted embedding vector to the AI server 200. The cloud AI model 450 of the AI server 200 may access the product database 620 through a data search API based on the embedding vector to obtain information about the washing machine.

The AI device 100 may output a response requesting a provision of an audio recording of the mentioned issue, such as <“Please provide audio recording of the mentioned issue”>, through the on-device AI model 430.

The AI device 100 may convert an audio sample recorded by a customer into an embedding vector and transmit the converted embedding vector to the AI server 200. The cloud AI model 450 of the AI server 200 may access the maintenance database 630 through a data search API based on the embedding vector to determine whether maintenance data matching the embedding vector is stored.

If the maintenance data matching the embedding vector is stored, the cloud AI model 450 of the AI server 200 may generate a response based on the stored maintenance data and transmit the response to the AI device 100. In this case, the AI device 100 may output the response <“This is a known issue. We will send you a replacement part to you. Please come back to this chat once you receive the part for further instructions”> through the on-device AI model 430.

The customer may confirm receipt of replacement parts through the chatbot, and the AI device 100 may output verbal/text instructions based on maintenance data for guiding replacement parts obtained from the maintenance database 630.

If maintenance data matching the embedding vector is not stored, the cloud AI model 450 of the AI server 200 may generate a response indicating that the issue cannot be identified and transmit it to the AI device 100. In this case, the AI device 100 may output the response <“We can't seem to identify the issue. We may schedule an in-person maintenance for you.”> through the on-device AI model 430.

Afterwards, the customer sets up a schedule for human support.

In this way, according to the embodiment of the present disclosure, the primary resolution of a problem may be achieved without the intervention of a customer support representative (consultant), thereby reducing a labor and an operating cost and shortening a response time.

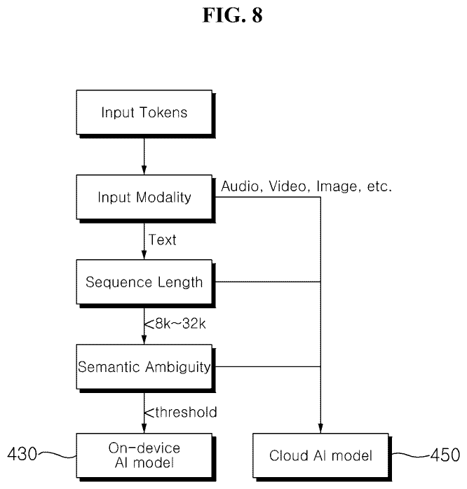

FIG. 8 is a diagram illustrating a process for determining an AI model to provide an answer to input data according to one embodiment of the present disclosure.

Hereinafter, the on-device AI model 430 may be provided in the AI device 100, and the cloud AI model 450 may be provided in the AI server 200, but is not limited thereto. The cloud AI model 450 may also be provided in the AI device 100. In this case, the processor 180 may select either the on-device AI model 430 or the cloud AI model 450 provided in the AI device 100 according to the selection criteria described below.

Referring to FIG. 8, the processor 180 of the AI device 100 may tokenize the user's input data to generate input tokens.

The processor 180 may determine an input modality of the input data based on the input tokens. The input modality or a modality may indicate what type of data the input tokens belong to.

The processor 180 may determine the modality of input data by analyzing a modality identifier included in the input tokens.

The processor 180 may determine an AI model to provide an answer to the input data as the cloud AI model 450 when the determined modality is any one of audio, video, image, or document.

If the determined modality is the text, the processor 180 may calculate a sequence length of the text. The sequence length may be the number of input tokens. If the sequence length for the text is greater than a certain length (if the number of input tokens is greater than a certain number), the processor 180 may determine an AI model that will provide an answer to the input data as the cloud AI model 450. The certain length may be determined based on an architecture of the on-device AI model 430 as well as a resource constraint such as a GPU, a CPU computing, and a RAM provided in the AI device 100.

The architecture of the on-device AI model 430 may indicate a design structure and a configuration method of the on-device AI model 430 that is built into and operated by the AI device 100. For example, the architecture of the on-device AI model 430 may include a type, a number, and a connection method of neural network layers.

When the sequence length for the text is less than the certain length, the processor 180 may convert input tokens into an embedding vector, and determine a semantic ambiguity of the input data based on the converted embedding vector. The semantic ambiguity may refer to the complexity described above.

The lightweight converter 420 of the processor 180 described in FIGS. 3 and 4 may calculate the complexity of input data using the embedding vector as input.

If the complexity calculated based on the embedding vector is greater than a threshold value, the processor 180 may determine that there is the semantic ambiguity in the input data, and may determine an AI model that will provide an answer to the input data as the cloud AI model 450.

If the complexity calculated based on the embedding vector is less than the threshold value, the processor 180 may determine that there is no semantic ambiguity in the input data, and may determine the AI model that will provide an answer to the input data as the on-device AI model 430.

In one embodiment, the threshold value used to determine the complexity of input data may be dynamically changed depending on a network condition. For example, the processor 180 may dynamically adjust the threshold value upward when the network connection is unstable or bandwidth is limited.

In one embodiment, the processor 180 may determine that a network connection status is unstable if a time it takes for input data to be transmitted from the AI device 100 to the cloud AI model 450 and for a response to be returned is greater than a reference time.

In another embodiment, the processor 180 may determine that a bandwidth of the network is limited if an amount of data transmitted per unit time is less than a reference amount.

Thus, according to embodiments of the present disclosure, when the network condition deteriorates, the threshold value used to determine complexity may be dynamically increased. Accordingly, even when the network condition deteriorates, continuous responses to user queries are possible through the on-device AI model.

An artificial intelligence device 100 according to one embodiment of the present disclosure may comprise an output interface 150; a memory 170 configured to store a lightweighted on-device AI model 430; a communication interface 110 configured to communicate with an AI server 200 including a cloud AI model 450 running in a cloud computing environment; and at least one processor 180 configured to: obtain input data, determine an AI model to provide an answer to the input data among the on-device AI model and the cloud AI model based on a modality or a complexity of the obtained input data, obtain the answer through the determined AI model, and output the obtained answer through the output interface.

The at least one processor 180 may convert the input data into an embedding vector, if the on-device AI model 430 is determined as the AI model that provide the answer, obtain a first answer by inputting the converted embedding vector into the on-device AI model 430, and if the cloud AI model 450 is determined as the AI model to provide the answer, transmit the embedding vector the AI server through the communication interface and receive, from the AI server, a second answer generated from the embedding vector through the cloud AI model 450.

The at least one processor 180 may convert the input data into a plurality of input tokens, determine the modality of the input data based on the converted plurality of input tokens, and determine the AI model to provide the answer based on whether the modality is one of an image, an audio, a video, or a document as the cloud AI model 450.

The at least one processor 180 may determine the AI model that provides the answer as the cloud AI model 450 based on a determination that the modality of the input data is a text, and the number of the plurality of input tokens is greater than a certain number.

The at least one processor 180 may determine the complexity of the input data if the number of the plurality of input tokens is less than or equal to the certain number, determine the AI model that provide the answer as the cloud AI model 450 based on the determined complexity being greater than the threshold value, and determine the AI model that provides the answer as the on-device AI model 430 based on the determined complexity being less than the threshold value.

Wherein on-device AI model 430 is a model that performs a device information retrieval function, a customer information query function, and a lightweight image generation function in response to the input data to output a performance result as the answer, and wherein cloud AI model is a model that performs a multimodal understanding function, a long-context-aware attention function, and a retrieval-augmented generation of solution function in response to the input data to output performance result as the answer.

The output interface 150 may comprise a display 151 configured to display a digital human, and an audio output interface 152 configured to output a voice corresponding to the answer, wherein the at least one processor 180 may output the voice while displaying a pose of the digital human that matches the voice.

The functions of the elements disclosed in the present invention may be implemented using circuits or processing circuits including general-purpose processors, special-purpose processors, integrated circuits, application-specific integrated circuits (ASICs), existing circuits, and/or combinations thereof. A processor may be defined as a processing circuit or circuits including transistors and other circuits.

In the present invention, the circuits, units, or means may be hardware designed or programmed to perform the specified functions. The hardware may be the hardware disclosed in the present invention or other known hardware programmed or configured to perform the specified functions. If the hardware is a processor, which may be considered a type of circuit, the circuits, units, or means may be a combination of hardware and software, and the software may constitute the hardware and/or the processor.

The above-described present disclosure may be implemented as a computer-readable code on a medium in which a program is recorded. The computer-readable medium includes all kinds of recording devices in which data that may be read by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. In addition, the computer may include the processor 180 of an artificial intelligence device.

What is claimed is:

1. An artificial intelligence (AI) device, comprising:
an output interface;
a memory configured to store a lightweighted on-device AI model;
a communication interface configured to communicate with an AI server including a cloud AI model running in a cloud computing environment; and
at least one processor configured to:
obtain input data,
determine an AI model to provide an answer to the input data among the on-device AI model and the cloud AI model based on a modality or a complexity of the obtained input data,
obtain the answer through the determined AI model, and
output the obtained answer through the output interface.

2. The AI device of claim 1, wherein the at least one processor is further configured to:
convert the input data into an embedding vector,
if the on-device AI model is determined as the AI model that provide the answer, obtain a first answer by inputting the converted embedding vector into the on-device AI model, and
if the cloud AI model is determined as the AI model to provide the answer, transmit the embedding vector the AI server through the communication interface and receive, from the AI server, a second answer generated from the embedding vector through the cloud AI model.

3. The AI device of claim 1, wherein the at least one processor is further configured to:
convert the input data into a plurality of input tokens,
determine the modality of the input data based on the converted plurality of input tokens, and
determine the AI model to provide the answer based on whether the modality is one of an image, an audio, a video, or a document as the cloud AI model.

4. The AI device of claim 3, wherein the at least one processor is further configured to:
determine the AI model that provides the answer as the cloud AI model based on a determination that the modality of the input data is a text, and the number of the plurality of input tokens is greater than a certain number.

5. The AI device of claim 4, wherein the at least one processor is further configured to:
determine the complexity of the input data if the number of the plurality of input tokens is less than or equal to the certain number,
determine the AI model that provide the answer as the cloud AI model based on the determined complexity being greater than the threshold value, and
determine the AI model that provides the answer as the on-device AI model based on the determined complexity being less than the threshold value.

6. The AI device of claim 1, wherein on-device AI model is a model that performs a device information retrieval function, a customer information query function, and a lightweight image generation function in response to the input data to output a performance result as the answer, and
wherein cloud AI model is a model that performs a multimodal understanding function, a long-context-aware attention function, and a retrieval-augmented generation of solution function in response to the input data to output performance result as the answer.

7. The AI device of claim 1, wherein the output interface comprises:
a display configured to display a digital human, and
an audio output interface configured to output a voice corresponding to the answer,
wherein the at least one processor is further configured to output the voice while displaying a pose of the digital human that matches the voice.

8. A method of providing an on-demand service, comprising:
obtaining input data;
determining an AI model to provide an answer to the input data among an on-device AI model and a cloud AI model based on a modality or a complexity of the obtained input data;
obtaining the answer through the determined AI model; and
outputting the obtained answer.

9. The method of claim 8, further comprising:
converting the input data into an embedding vector,
wherein the obtaining the answer comprises:
if the on-device AI model is determined as the AI model that provide the answer, obtaining a first answer by inputting the converted embedding vector into the on-device AI model, and
if the cloud AI model is determined as the AI model to provide the answer, transmitting the embedding vector the AI server through the communication interface and receiving, from the AI server, a second answer generated from the embedding vector through the cloud AI model.

10. The method of claim 8, wherein the determining the AI model comprises:
converting the input data into a plurality of input tokens,
determining the modality of the input data based on the converted plurality of input tokens, and
determining the AI model to provide the answer based on whether the modality is one of an image, an audio, a video, or a document as the cloud AI model.

11. The method of claim 10, wherein the determining the AI model comprises:
determining the AI model that provides the answer as the cloud AI model based on a determination that the modality of the input data is a text, and the number of the plurality of input tokens is greater than a certain number.

12. The method of claim 11, wherein the determining the AI model comprises:
determining the complexity of the input data if the number of the plurality of input tokens is less than or equal to the certain number,
determining the AI model that provide the answer as the cloud AI model based on the determined complexity being greater than the threshold value, and
determining the AI model that provides the answer as the on-device AI model based on the determined complexity being less than the threshold value.

13. The method of claim 8, wherein on-device AI model is a model that performs a device information retrieval function, a customer information query function, and a lightweight image generation function in response to the input data to output a performance result as the answer, and
wherein cloud AI model is a model that performs a multimodal understanding function, a long-context-aware attention function, and a retrieval-augmented generation of solution function in response to the input data to output performance result as the answer.

14. The method of claim 8, wherein the outputting the obtained answer comprises:
outputting the voice while displaying a pose of the digital human that matches the voice.

15. A non-transitory recording medium storing computer-readable instructions that, when executed by a device, cause the device to perform a method,
wherein the method comprises:
obtaining input data;
determining an AI model to provide an answer to the input data among an on-device AI model and a cloud AI model based on a modality or a complexity of the obtained input data;
obtaining the answer through the determined AI model; and
outputting the obtained answer.
